(19) United States
(12) Patent Application Publication
(10) Pub. No.: US 2008/0118220 A1
(43) Pub. Date: May 22, 2008

(54) Method of capturing still image during reproduction of moving picture

(75) Inventors: Se-hyun Park, Seoul (KR); Na-ri Choi, Seoul (KR); Sung-cheol Bae, Seoul (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/732,671

(22) Filed: Apr. 4, 2007

(30) Foreign Application Priority Data
Nov. 15, 2006 (KR) 10-2006-0113039

(51) Int. Cl. H04N 5/91

(52) U.S. Cl. 386/68

(57) ABSTRACT

A method of capturing a still image during reproduction of a moving picture is provided. The method includes reproducing the moving picture at a slow speed when a first input signal is received during reproduction of the moving picture; and capturing a still image from the moving picture, which is being reproduced at the slow speed, when a second input signal is received.

### CROSS-REFERENCE TO RELATED PATENT APPLICATIONS

This application claims the benefit of the filing date of Korean Patent Application No. 10-2006-0113039, filed on Nov. 15, 2006, in the Korean Intellectual Property Office, which is incorporated herein in its entirety by reference.

### BACKGROUND OF THE INVENTION

1. Field of the Invention

The present invention relates to a method of operating an image reproducing apparatus and, more particularly, to a method of capturing a still image during reproduction of a moving picture.

2. Description of the Related Art

Recently, video cameras or digital cameras capable of shooting high-quality moving pictures for high-definition (HD) broadcasting have been introduced. The picture quality of HD digital broadcasts allows a captured still image to have satisfactory picture quality and thus there has been demand for capturing still images during broadcasting. However, an optimal method of capturing a desired still image has not been proposed. Although a method of capturing a still image during a pause state and a method of stopping a moving picture using a capture button during reproduction of the moving picture have been suggested, however, it is difficult to capture a desired scene using these methods.

### SUMMARY OF THE INVENTION

The present invention provides a method of capturing a still image during reproduction of a moving picture using a two-step switch, in which the moving picture is reproduced at a slow speed when a first-step switch signal is input and a still image is captured when a second-step switch signal is input.

The present invention also provides a method of capturing a still image during reproduction of a moving picture using a two-step switch, in which the moving picture is shifted back by a predetermined interval and reproduced starting from the beginning of the predetermined interval that was reproduced before an input of a first-step switch signal when the first-step switch is input and a still image is captured when a second-step switch signal is input.

According to an aspect of the present invention, there is provided a method of capturing a still image while an image reproducing apparatus is reproducing a moving picture. The method includes reproducing the moving picture at a slow speed when a first input signal is received during reproduction of the moving picture; and capturing a still image from the moving picture, which is being reproduced at the slow speed, when a second input signal is received.

The image reproducing apparatus may be a digital camera that can perform image capturing and reproducing.

The first and second input signals may be respectively first and second shutter-release button input signals of a two-step button of the digital camera.

The moving picture may be reproduced at the slow speed as long as the first shutter-release button input signal is maintained.

The still image may be captured in response to the second shutter-release button input signal and then the moving picture may be reproduced at a normal speed.

When the first shutter-release button input signal is received once without being maintained, the moving picture may be reproduced at the slow speed.

The still image may be captured when the first and second shutter-release button input signals are consecutively received.

According to another aspect of the present invention, there is provided a method of capturing a still image while an image reproducing apparatus is reproducing a moving picture. The method includes shifting the moving picture back from a point of time corresponding to reception of a first input signal by a predetermined interval when the first input signal is received during reproduction of the moving picture; and capturing a still image from the moving picture, which is being reproduced, when a second input signal is received.

The method may further include reproducing the moving picture at a slow speed from a beginning of the predetermined interval after shifting of the moving picture.

The image reproducing apparatus may be a digital camera that can perform image capturing and reproducing.

The first and second input signals may be respectively first and second shutter-release button input signals of a two-step button comprised in the digital camera.

The moving picture may be reproduced at the slow speed as long as the first shutter-release button input signal is maintained.

The still image may be captured in response to the second shutter-release button input signal and then the moving picture may be reproduced at a normal speed.

When the first shutter-release button input signal is received once without being maintained, the moving picture may be reproduced at the slow speed.

When the first shutter-release button input signal is received, the moving picture may be reproduced at a slow speed from the beginning of the predetermined interval during the predetermined interval.

The still image may be captured when the first and second shutter-release button input signals are consecutively received during the predetermined interval.

The moving picture may be reproduced at a normal speed when the predetermined interval has lapsed.

Yet another aspect of the invention includes an image reproducing apparatus comprising a storage unit that stores data representing a moving picture, a user input means that generates a first signal and a second signal, a display unit including a display screen that displays the moving picture at a first speed, and a control unit. In response to the first signal, the control unit causes the image reproducing apparatus to shift the moving picture back by a predetermined interval and display the moving picture on the display unit from the beginning of the interval at a second speed that is slower than the first speed. In response to the second signal, the control unit causes the image reproducing apparatus to capture a still image from the moving picture while the moving picture is being displayed at the second speed, and store the still image in the storage unit. The user input means may be a shutter release button.

The image reproducing apparatus may further include a lens that receives light from a source external to the image reproducing apparatus, a charge-coupled device that converts the light into an analog signal representing the moving picture, and an analog to digital converter that converts the analog signal into a digital signal representing the moving picture, the data of which is then stored in the storage unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view showing the front and top of a digital image processing apparatus that is used as an image reproducing apparatus;

FIG. 2 is a rear view of the digital image processing apparatus illustrated in FIG. 1;

FIG. 3 is a block diagram of a digital image processing apparatus;

FIG. 4 is a flowchart of a method of capturing a still image during reproduction of a moving picture according to an embodiment of the present invention;

FIG. 5 is a timing diagram of the method illustrated in FIG. 4;

FIG. 6 is a flowchart of a method of capturing a still image during reproduction of a moving picture according to another embodiment of the present invention;

FIG. 7 is a timing diagram of the method illustrated in FIG. 6;

FIG. 8 is a flowchart of a method of capturing a still image during reproduction of a moving picture according to another embodiment of the present invention; and

FIG. 9 is a timing diagram of the method illustrated in FIG. 8.

### DETAILED DESCRIPTION OF THE INVENTION

Hereinafter, preferred embodiments of the present invention will be described in detail with reference to the attached drawings. Like reference numerals in the drawings denote like elements.

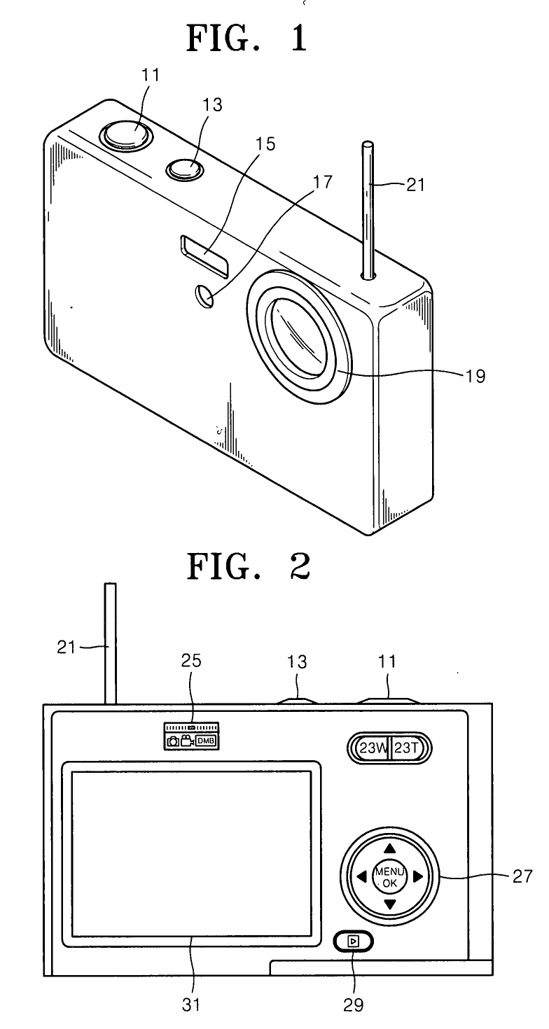

FIG. 1 is a perspective view showing the front and top of a digital image processing apparatus that is used as an image reproducing apparatus. Referring to FIG. 1, the digital image processing apparatus includes a shutter-release button 11, a power button 13, a flash 15, an auxiliary light 17, a lens unit 19, and a digital multimedia broadcasting (DMB) antenna 21.

The shutter-release button 11 is closed and opened in order to expose a charge-coupled device (CCD) and records pictures in the CCD by appropriate exposure by operating an iris (not shown). The shutter-release button 11 generates a first shooting signal and a second shooting signal in response to a user's input. The first shooting signal corresponds to a half-pushed shutter signal and the second shooting signal corresponds to a full-pushed shutter signal. When the first shooting signal is input, the digital image processing apparatus focuses and adjusts the quantity of light. When the digital image processing apparatus is in focus, green light appears on a display panel (display panel 31 in FIG. 2). Thereafter, shooting is performed when the second shooting signal is input.

The power button 13 is used to provide power to the digital image processing apparatus and operate it. The flash 15 momentarily throws light on a subject when shooting is performed in the dark. Flash modes include an automatic flash mode, a compulsory flash mode, a no flash mode, a red-eye reduction mode, and a slow sync mode.

The auxiliary light 17 emits light to a subject when the quantity of light is deficient or during night shooting so that the digital image processing apparatus can automatically focus on the subject quickly and accurately. The lens unit 19 receives light from an external light source and processes images. The DMB antenna 21 receives DMB and may be detachable.

FIG. 2 is a rear view of the digital image processing apparatus illustrated in FIG. 1. Referring to FIG. 2, the digital image processing apparatus includes a wide angle-zoom button 23W, a telephoto-zoom button 23T, a mode switch 25, a function button 27, a moving picture play/stop button 29, and a display panel 31.

When the wide angle-zoom button 23W is pressed, the angle of view is widened. When the telephoto-zoom button 23T is pressed, the angle of view is narrowed. In particular, these two buttons 23W and 23T are used to change the size of a selected exposure area. When the wide angle-zoom button 23W is pressed, the size of the selected exposure area is decreased. When the telephoto-zoom button 23T is pressed, the size of the selected exposure area is increased.

The mode switch 25 is used to minimize a user's setup and to quickly and simply perform shooting. Modes selected by the mode switch 25 may be a still picture mode for taking still pictures, a moving picture mode for taking moving pictures, and a DMB mode for receiving DMB, but the present invention is not restricted thereto.

The function button 27 includes five buttons including an up button, a down button, a left button, a right button, and a menu/OK button. The function button 27 is used to execute various menus related to the operations of the digital image processing apparatus and may be used as a short-cut key.

The moving picture play/stop button 29 is used to play or stop moving pictures.

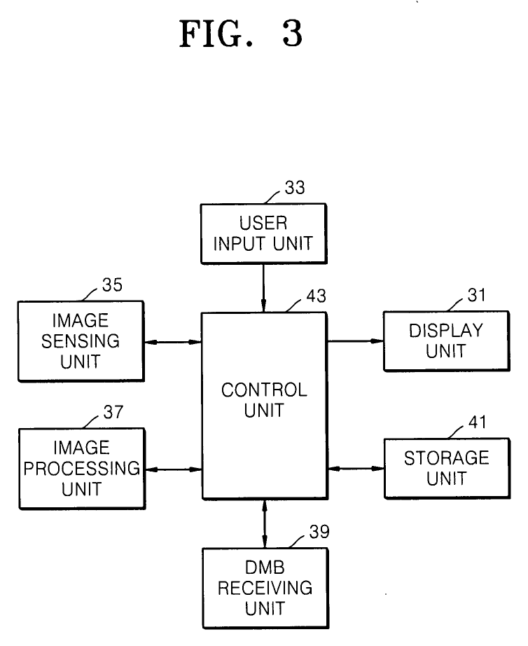

FIG. 3 is a block diagram of the digital image processing apparatus illustrated in FIGS. 1 and 2. The digital image processing apparatus includes a display unit 31, a user input unit 33, an image sensing unit 35, an image processing unit 37, a DMB receiving unit 39, a storage unit 41, and a control unit 43.

Referring to FIGS. 1 and 2, the user input unit 33 includes the shutter-release button 11 which is opened and closed to expose a CCD or a film to light for a predetermined period of time, the power button 13 which turns on of off the digital image processing apparatus, the wide angle-zoom button 23W which widens the angle of view, the telephoto-zoom button 23T which narrows the angle of view, the mode switch 25 which is used to minimize a user's setup and to quickly and simply perform shooting, the function button 27 which is used to execute various menus related to the operations of the digital image processing apparatus, and the moving picture play/stop button 29 which is used to play or stop moving pictures.

The image sensing unit 35 includes the shutter-release button 11, the lens unit 19, the iris, the CCD, and an analog-to-digital converter (ADC). The shutter-release button 11 adjusts the quantity of exposure light by using the iris. The lens unit 19 receives light from an external light source and processes an image. In this case, the iris is opened or closed in order to adjust the quantity of incident light. The degree of opening/closing of the iris is controlled by the control unit 43. The CCD accumulates light input through the lens unit 19 and outputs an image, which is sensed by the lens unit according to the quantity of the accumulated light, in synchronization with a vertical sync signal. The image acquisition performed by the digital image processing apparatus is carried out by the CCD which converts light reflected from a subject into an electrical signal. In order to obtain a color image using the CCD, a color filter is needed. Usually, a color filter array (CFA) is used as the color filter. The CFA passes only light expressing a single color per pixel and has a regular arrangement. The CFA may be divided into various types according to an arrangement of the structure. The ADC converts an analog image signal output from the CCD into a digital signal.

The image processing unit 37 processes a digitized image signal so that it can be displayed. Elements used in the CCD and the CFA are sensitive to the changes in temperature and thus generate dark current according to changing temperature, which results in a black level in the image signal. The image processing unit 37 removes the black level caused by the dark current. In addition, the image processing unit 37 performs gamma correction. Human sight reacts non-linearly to brightness according to Weber's law. When the brightness of light is linearly recorded using a limited bit depth, posterization occurs. Accordingly, in order to provide the highest picture quality at a given bit depth, it is necessary to perform coding using a non-linear function. The operation of coding information to agree with the non-linearity of human sight is referred to as gamma correction. The image processing unit 37 performs gamma correction on an input image signal using a gamma curve. For example, the image processing unit 37 corrects the input luminance level of a 12-bit image signal into the luminance level of an 8-bit image signal.

The image processing unit 37 also performs CFA interpolation, by which a Bayer pattern including an RGRG line and a GBGB line of gamma corrected data is interpolated by an RGB line. When the CFA interpolation of the image processing unit 37 is performed, a G channel is first restored in pixels that have only an R or B channel value and then empty values are filled in order of B and R or R and B channels. As such, three R, G, and B channels are restored. The image processing unit 37 converts interpolated RGB signals into YUV signals, performs edge compensation to sharpen an image by filtering a Y signal using a high pass filter and color correction to correct color values of U and V signals using a standard color coordinate system, and removes noise. Thereafter, the image processing unit 37 performs compression and signal processing on the Y, U, and V signals, from which noise was removed, so as to generate an Exif file. The Exif file is displayed by the display unit 31 and stored in the storage unit 41 according to the user's selection.

All operations of the image processing unit 37 are controlled by the control unit 43. In particular, when a moving picture reproducing mode is selected by the user, the image processing unit 37 reproduces a moving picture stored in the storage unit 41 and displays it on the display unit 31. At this time, the image processing unit 37 is controlled by the control unit 43 to reproduce the moving picture at a normal speed or a slow speed. In addition, the image processing unit 37 is controlled by the control unit 43 to capture a still image during the reproduction of the moving picture, perform the above-described signal processing, display a signal processed still image on the display unit 31, and store the still image in the storage unit 41.

The DMB receiving unit 39 receives a terrestrial DMB signal or a satellite DMB signal through the DMB antenna 21 according to the user's selection. The received DMB signal is controlled by the control unit 43 to be processed by the image processing unit 37 so as to be displayable and to be stored in the display unit 31. According to the control of the control unit 43, the DMB receiving unit 39 may always store three or four minutes of the DMB signal in the storage unit 41. The DMB signal displayed on the display unit 31 may be recorded in the storage unit 41 according to the user's selection.

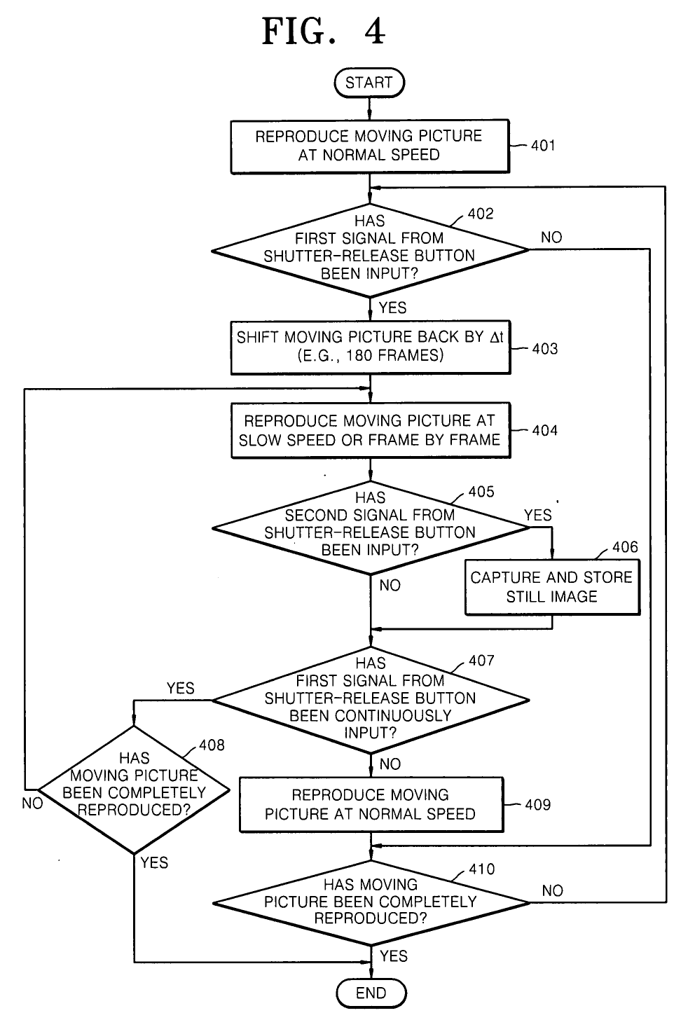

Hereinafter, methods of capturing a still image while a digital image processing apparatus that is used as an image reproducing apparatus is reproducing a moving picture according to embodiments of the present invention will be described in detail with reference to FIGS. 4 through 9. The methods may be performed within the digital image processing apparatus illustrated in FIG. 3. According to embodiments of the present invention, main algorithms of the methods of capturing a still image during reproduction of a moving picture may be performed within the control unit 43 with the assistance of peripheral members in the digital image processing apparatus.

The methods of capturing a still image during reproduction of a moving picture are performed in two main modes.

In the first mode, when a first input signal is received while the moving picture is being reproduced, the moving picture is reproduced at a slow speed. Thereafter, when a second input signal is received, a still image is captured from the moving picture that is being reproduced at the slow speed. In this case, there are many types of apparatuses that can reproduce the moving picture. However, for clarity of description, it is assumed that a digital image processing apparatus that can perform image shooting and reproducing is used in the embodiments of the present invention, which will be described below. The moving picture reproduced by the digital image processing apparatus may be a moving picture that has been taken by a user and stored in the storage unit 41, a DMB signal of three or four minutes that has been received through the DMB antenna 21 and stored in the storage unit 41, or a DMB signal that has been already recorded in the storage unit 41.

In the second mode, when the first input signal is received while the digital image processing apparatus is reproducing a moving picture, the moving picture is shifted back by a predetermined interval before the input of the first input signal and then reproduced. Thereafter, when the second input signal is received, a still image is captured from the moving picture that is being reproduced.

Based on the first mode and/or the second mode described above, first through third embodiments of the present invention will be described below.

FIG. 4 is a flowchart of a method of capturing a still image during reproduction of a moving picture according to a first embodiment of the present invention. In operation 401, the control unit 43 reproduces a selected moving picture at normal speed. In detail, a user sets the mode switch 25 to a moving picture reproducing mode, selects a moving picture reproducing signal stored in the storage unit 41, and presses the moving picture play/stop button 29. Then, the control unit 43 generates a signal processing control command to control the image processing unit 37 to reproduce the selected moving picture at normal speed. Upon receiving the signal processing control command, the image processing unit 37 displays the signal-processed moving picture on the display unit 31 at normal speed.

In operation 402, the control unit 43 determines whether a first signal from the shutter-release button 11 is input as a half-shutter while the moving picture is being reproduced. When the first signal from the shutter-release button 11 is input during the reproduction of the moving picture, the moving picture is shifted back by a predetermined interval before the input of the first signal from the shutter-release button 11 and is reproduced from the beginning of the interval at a slow speed.

When it is determined that the first signal from the shutter-release button 11 has been input during the reproduction of the moving picture, the control unit 43 stops the reproduction of the moving picture and shifts back a current point of the moving picture by Δt in operation 403. Here, Δt is the predetermined interval backward from the input of the first signal from the shutter-release button 11 and may be a predetermined period of time, e.g., 3 seconds, or a predetermined number of frames, e.g., 90 frames.

Thereafter, in operation 404, the control unit 43 reproduces the moving picture from the beginning of the predetermined interval of Δt at the slow speed or frame by frame.

In operation 405, the control unit 43 determines whether a second signal from the shutter-release button 11 has been input as a full shutter while the moving picture is being reproduced at the slow speed or frame by frame. When the second signal from the shutter-release button 11 is input while the moving picture is being reproduced at the slow speed or frame by frame, a still image is captured.

In operation 406, the control unit 43 captures a still image and stores it in the storage unit 41 at the moment when it is determined that the second signal from the shutter-release button 11 has been input. Here, the captured still image may be converted into a JPEG file or other compressed file by the image processing unit 37 and stored in the storage unit 41. Alternatively, the captured still image may be temporarily stored in a buffer (not shown), then converted into a JPEG file or other compressed file by the image processing unit 37 when the reproduction of the moving picture is completed, and then stored in the storage unit 41. Upon receiving the second signal from the shutter-release button 11, the control unit 43 generates a still image capture command to control the image processing unit 37 and the image processing unit 37 captures a still image, performs signal processing on the still image, and stores the signal-processed still image in the storage unit 41 according to the control of the control unit 43.

In operation 407, the control unit 43 determines whether the first signal from the shutter-release button 11 has been continuously input since the still image was captured. When it is determined that the first signal from the shutter-release button 11 has been continuously input, the control unit 43 determines whether the moving picture has been completely reproduced in operation 408. When it is determined that the moving picture has not been completely reproduced in operation 408, the control unit 43 returns to operation 404. Accordingly, whenever the second signal from the shutter-release button 11 is input while the first signal from the shutter-release button 11 is being input, a still image can be captured. As a result, a plurality of still images can be easily captured in the method.

However, when it is determined that the first signal from the shutter-release button 11 has not been continuously input since the second signal from the shutter-release button 11 was input, the control unit 43 reproduces the moving picture at normal speed from a point corresponding to the input of the second signal from shutter-release button 11 in operation 409.

Thereafter, when it is determined that the moving picture has been completely reproduced at normal speed in operation 410, the control unit 43 terminates the method. After the completion of the reproduction of the moving picture, the control unit 43 displays captured still images on the display unit 31 so that the user can check the captured still images.

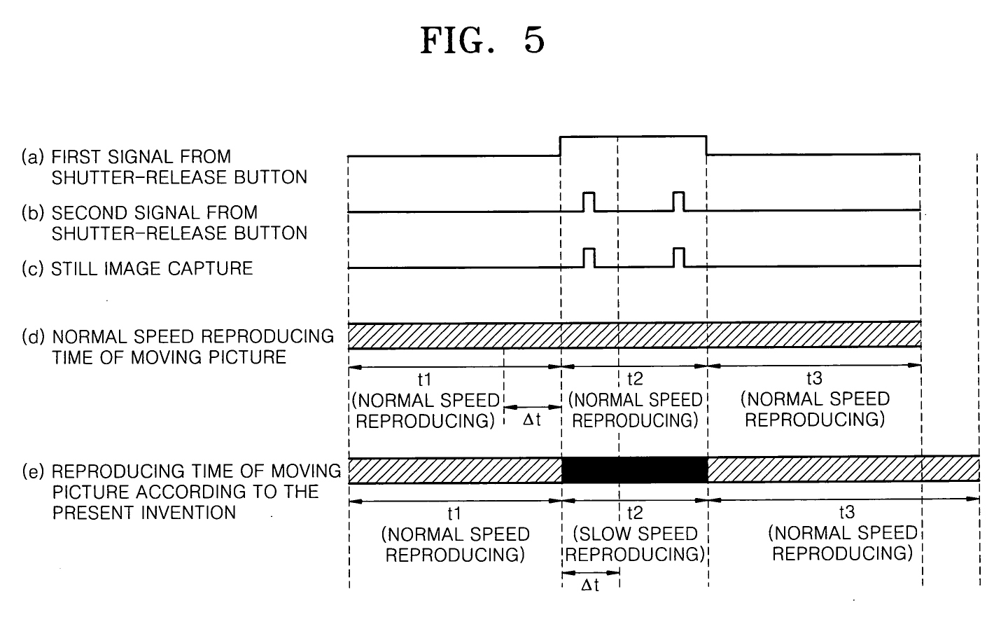

FIG. 5 is a timing diagram of the method illustrated in FIG. 4. In FIG. 5, (a) denotes the first signal from the shutter-release button 11; (b) denotes the second signal from the shutter-release button 11; (c) denotes capture of a still image at the second signal from the shutter-release button 11; (d) denotes a normal speed reproducing time of the moving picture; and (e) denotes a reproducing time of the moving picture according to the first embodiment of the present invention. Referring to FIG. 5, when the first signal from the shutter-release button 11 is input, the moving picture is shifted back by Δt from a point corresponding to the input of the first signal from the shutter-release button 11 and is reproduced at a slow speed. At each time when the second signal from the shutter-release button 11 is input while the moving picture is reproduced at the slow speed, a still image is captured.

When the moving picture is reproduced at normal speed, as illustrated in FIG. 5(d), the moving picture is reproduced at normal speed during all sections t1, t2, and t3 even if the moving picture is shifted back by Δt by the input of the first signal from the shutter-release button 11. However, as illustrated in FIG. 5(e), when the first signal from the shutter-release button 11 is input while the moving picture is reproduced at normal speed in the section t1, the moving picture is shifted back by Δt from the point of input of the first signal from the shutter-release button 11 and is reproduced at the slow speed. The slow-speed reproduction is continued as long as the first signal from the shutter-release button 11 is continuously input in the section t2. During the section t2, a still image is captured each time the second signal from the shutter-release button 11 is input. When the input of the first and second signals from the shutter-release button 11 is finished, the moving picture is reproduced at normal speed in the section t3.

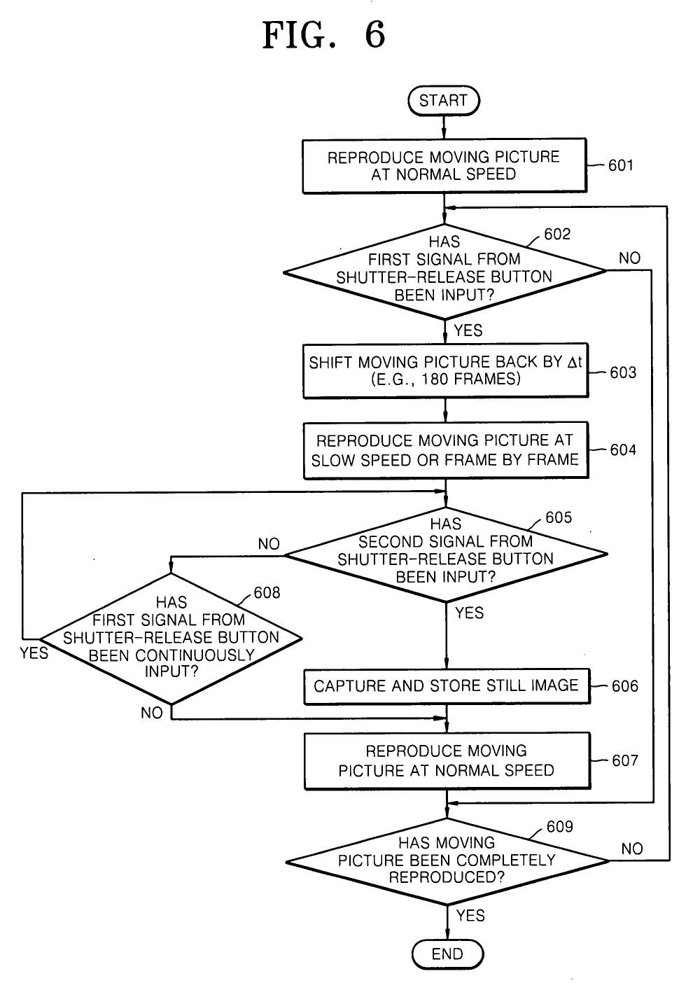

FIG. 6 is a flowchart of a method of capturing a still image during reproduction of a moving picture according to a second embodiment of the present invention. In operation 601, the control unit 43 reproduces a selected moving picture at normal speed. In detail, a user sets the mode switch 25 to a moving picture reproducing mode, selects a moving picture stored in the storage unit 41, and presses the moving picture play/stop button 29. Then, the control unit 43 generates a signal processing control command to control the image processing unit 37 to reproduce the selected moving picture at normal speed. Upon receiving the signal processing control command, the image processing unit 37 displays the signal-processed moving picture on the display unit 31 at normal speed.

In operation 602, the control unit 43 determines whether a first signal from the shutter-release button 11 has been input as a half-shutter while the moving picture is being reproduced. When the first signal from the shutter-release button 11 is input during the reproduction of the moving picture, the moving picture is shifted back by a predetermined interval before the input of the first signal from the shutter-release button 11 and is reproduced from the beginning of the interval at a slow speed.

When it is determined that the first signal from the shutter-release button 11 has been input during the reproduction of the moving picture, the control unit 43 stops the reproduction of the moving picture and shifts back a current point of the moving picture by Δt in operation 603. Here, Δt is the predetermined interval backward from the input of the first signal from the shutter-release button 11 and may be a predetermined period of time, e.g., 3 seconds, or a predetermined number of frames, e.g., 180 frames.

Thereafter, in operation 604, the control unit 43 reproduces the moving picture from the beginning of the predetermined interval of Δt at the slow speed or frame by frame.

In operation 605, the control unit 43 determines whether a second signal from the shutter-release button 11 has been input as a full shutter while the moving picture is being reproduced at the slow speed or frame by frame. When the second signal from the shutter-release button 11 is input while the moving picture is being reproduced at the slow speed or frame by frame, a still image is captured.

In operation 606, the control unit 43 captures a still image and stores it in the storage unit 41 at the moment when it is determined that the second signal from the shutter-release button 11 has been input. In this case, the captured still image may be converted into an Exif file by the image processing unit 37 and stored in the storage unit 41. Alternatively, the captured still image may be temporarily stored in a buffer (not shown), then converted into an Exif file by the image processing unit 37 when the reproduction of the moving picture is completed, and then stored in the storage unit 41. Upon receiving the input of the second signal from the shutter-release button 11, the control unit 43 generates a still image capture command in order to control the image processing unit 37 and the image processing unit 37 captures a still image, performs signal processing on the still image, and stores the signal-processed still image in the storage unit 41 according to the control of the control unit 43.

After the capture of the still image is completed, the control unit 43 continuously reproduces the moving picture at normal speed in operation 607. In the first embodiment, as long as the first signal from the shutter-release button 11 is continuously input, the moving picture is reproduced at the slow speed and a still image is captured each time the second signal from the shutter-release button 11 is input. However, in the second embodiment, when only the first signal from the shutter-release button 11 is input, the moving picture is reproduced at the slow speed, but once a still image is captured by the input of the second signal from the shutter-release button 11, the moving picture is continuously reproduced at normal speed.

However, when the second signal from the shutter-release button 11 is not input while the moving picture is being reproduced at the slow speed or frame by frame, the control unit 43 determines whether the first signal from the shutter-release button 11 has been continuously input in operation 608. When it is determined that the first signal from the shutter-release button 11 has been continuously input, the control unit 43 returns to operation 605. However, when it is determined that the first signal from the shutter-release button 11 has not been continuously input, the control unit 43 reproduces the moving picture from a point of time, which corresponds to the completion of still image capture, at normal speed in operation 607.

Thereafter, when the moving picture is completely reproduced at normal speed in operation 609, the control unit 43 terminates the method. After the completion of the reproduction of the moving picture, the control unit 43 displays captured still images on the display unit 31 so that the user can check the captured still images.

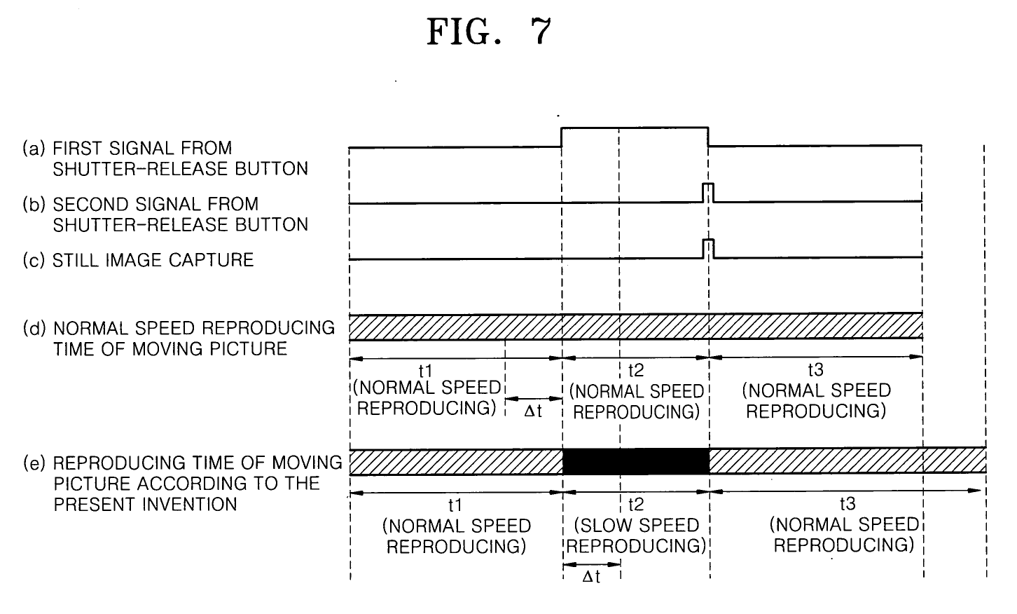

FIG. 7 is a timing diagram of the method illustrated in FIG. 6. In FIG. 7, (a) denotes the first signal from the shutter-release button 11; (b) denotes the second signal from the second shutter-release button 11; (c) denotes capture of still images at the input of the second signal from the shutter-release button 11; (d) denotes a normal speed reproducing time of the moving picture; and (e) denotes a reproducing time of the moving picture according to the first embodiment of the present invention. Referring to FIG. 7, when the first signal from the shutter-release button 11 is input, the moving picture is shifted back by Δt from a point corresponding to the input of the first signal from the shutter-release button 11 and is reproduced at the slow speed. Once the second signal from the shutter-release button 11 is input while the moving picture is reproduced at the slow speed, a still image is captured and then the moving picture is reproduced at normal speed.

When the moving picture is reproduced at normal speed, as illustrated in FIG. 7(d), the moving picture is reproduced at normal speed during all sections t1, t2, and t3 even if the moving picture is shifted back by Δt by the input of the first signal from the shutter-release button 11. However, as illustrated in FIG. 7(e), when the first signal from the shutter-release button 11 is input while the moving picture is reproduced at normal speed in the section t1, the moving picture is shifted back by Δt from the point of input of the first signal from the shutter-release button 11 and is reproduced at the slow speed. When the second signal from the shutter-release button 11 is input in the section t2 while the moving picture is reproduced at the slow speed, a still image is captured and then immediately the moving picture is continuously reproduced at normal speed in the section t3.

Referring to FIGS. 5 and 7, the first and second embodiments are the same in that the moving picture is reproduced at the slow speed once the first signal from the shutter-release button 11 is input. However, in the first embodiment, a plurality of still images can be captured by repeatedly inputting the second signal from the shutter-release button 11 while the first signal from the shutter-release button 11 is being input. In the second embodiment, after a single still image is captured by inputting the second signal from the shutter-release button 11, the moving image is reproduced at normal speed.

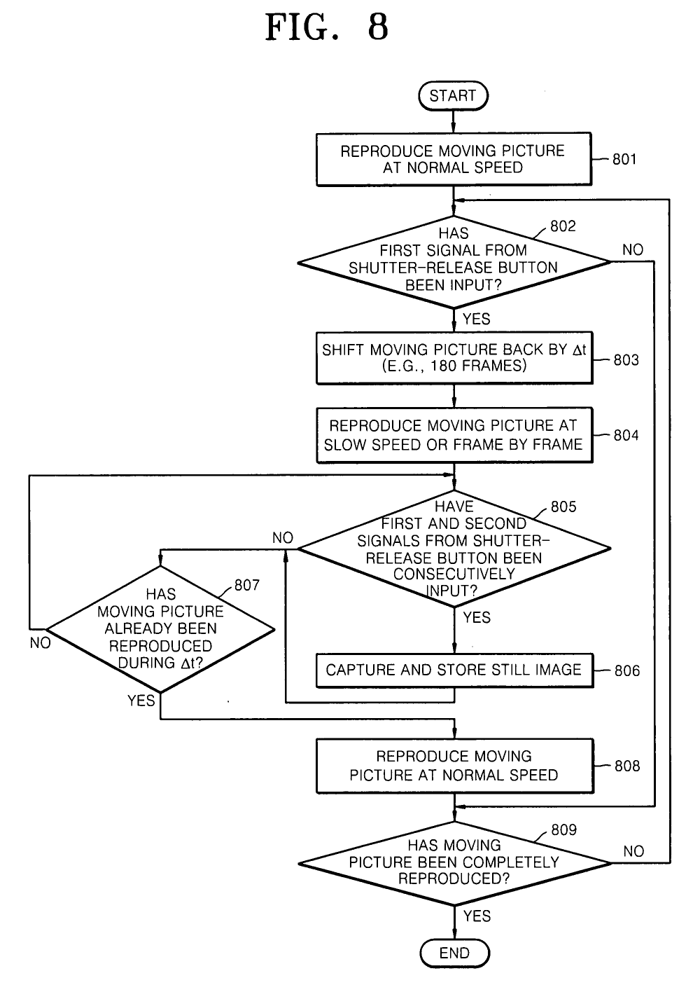

FIG. 8 is a flowchart of a method of capturing a still image during reproduction of a moving picture according to a third embodiment of the present invention. In operation 801, the control unit 43 reproduces a selected moving picture at normal speed. In detail, a user sets the mode switch 25 to a moving picture reproducing mode, selects a moving picture stored in the storage unit 41, and presses the moving picture play/stop button 29. Then, the control unit 43 generates a signal processing control command to control the image processing unit 37 to reproduce the selected moving picture at normal speed. Upon receiving the signal processing control command, the image processing unit 37 displays the signal-processed moving picture on the display unit 31 at normal speed.

In operation 802, the control unit 43 determines whether a first signal from the shutter-release button 11 has been input as a half-shutter while the moving picture is being reproduced. When the first signal from the shutter-release button 11 is input during the reproduction of the moving picture, the moving picture is shifted back by a predetermined interval before the input of the first signal from the shutter-release button 11 and is reproduced from the beginning of the interval at a slow speed.

When it is determined that the first signal from the shutter-release button 11 has been input during the reproduction of the moving picture, the control unit 43 stops the reproduction of the moving picture and shifts back a current point of the moving picture by Δt in operation 803. Here, Δt is the predetermined interval backward from the input of the first signal from the shutter-release button 11 and may be a predetermined period of time, e.g., 3 seconds, or a predetermined number of frames, e.g., 180 frames.

Thereafter, in operation 804, the control unit 43 reproduces the moving picture from the beginning of the predetermined interval of Δt at the slow speed or frame by frame. In the first and second embodiments, the input of the first signal from the shutter-release button 11 is maintained in order to keep the moving picture being reproduced at the slow speed. However, in the third embodiment, if the first signal from the shutter-release button 11 is input once, that is, the shutter-release button 11 is pressed half and then immediately released, the moving picture is shifted back by Δt and then reproduced at the slow speed.

In operation 805, the control unit 43 determines whether the first and second signals from the shutter-release button 11 have been consecutively input while the moving picture is being reproduced at the slow speed or frame by frame. When the first and second signals from the shutter-release button 11 are consecutively input while the moving picture is being reproduced at the slow speed or frame by frame, a still image is captured.

In operation 806, the control unit 43 captures a still image and stores it in the storage unit 41 at the moment when it is determined that the first and second signals from the shutter-release button 11 have been consecutively input. Here, the captured still image may be converted into an Exif file by the image processing unit 37 and stored in the storage unit 41. Alternatively, the captured still image may be temporarily stored in a buffer (not shown), then converted into an Exif file by the image processing unit 37 when the reproduction of the moving picture is completed, and then stored in the storage unit 41. Upon receiving the consecutive inputs of the first and second signals from the shutter-release button 11, the control unit 43 generates a still image capture command in order to control the image processing unit 37 and the image processing unit 37 captures a still image, performs signal processing on the still image, and stores the signal-processed still image in the storage unit 41 according to the control of the control unit 43.

After the capture of the still image is completed by continuous inputting of the first and second signals from the shutter-release button 11, the control unit 43 determines whether a moving picture has already been reproduced during Δt or not in operation 807. When it is determined that the moving picture has already been reproduced during Δt, the control unit 43 jumps to operation 804 and continuously reproduces the moving picture at the slow speed. When it is determined that the moving picture has not already been reproduced during Δt, the control unit 43 reproduces the moving image at the normal speed in operation 808.

Also when the first and second signals from the shutter-release button 11 are not con input in operation 805, the control unit 43 determines whether a moving picture has already been reproduced during Δt or not. When it is determined that the moving picture has not already been reproduced during Δt, the control unit 43 jumps to operation 804 and continuously reproduces a moving picture at the slow speed. When it is determined that the moving picture has already been reproduced during Δt, the control unit 43 jumps to operation 807 and reproduces the moving picture at the normal speed.

In the first embodiment, as long as the first signal from the shutter-release button 11 is continuously input or if the first signal from the shutter-release button 11 is input again, the moving picture is reproduced at the slow speed and a still image is captured each time the second signal from the shutter-release button 11 is input. In the second embodiment, when only the first signal from the shutter-release button 11 is input, the moving picture is reproduced at the slow speed, but once a still image is captured by the input of the second signal from the shutter-release button 11, the moving picture is continuously reproduced at normal speed. However, in the third embodiment, if the input of the first signal from the shutter-release button 11 is performed once without being maintained continuously, the moving pictures is shifted back by Δt and is reproduced at the slow speed until it is completely reproduced during Δt. Accordingly, as many still images as a user wants can be captured by consecutively inputting the first and second signals from the shutter-release button 11 while the moving picture corresponding to Δt is reproduced. When Δt is terminated, the moving picture is reproduced at normal speed.

Thereafter, when the moving picture is completely reproduced at normal speed in operation 809, the control unit 43 terminates the method. After the completion of the reproduction of the moving picture, the control unit 43 displays captured still images on the display unit 31 so that the user can check the captured still images.

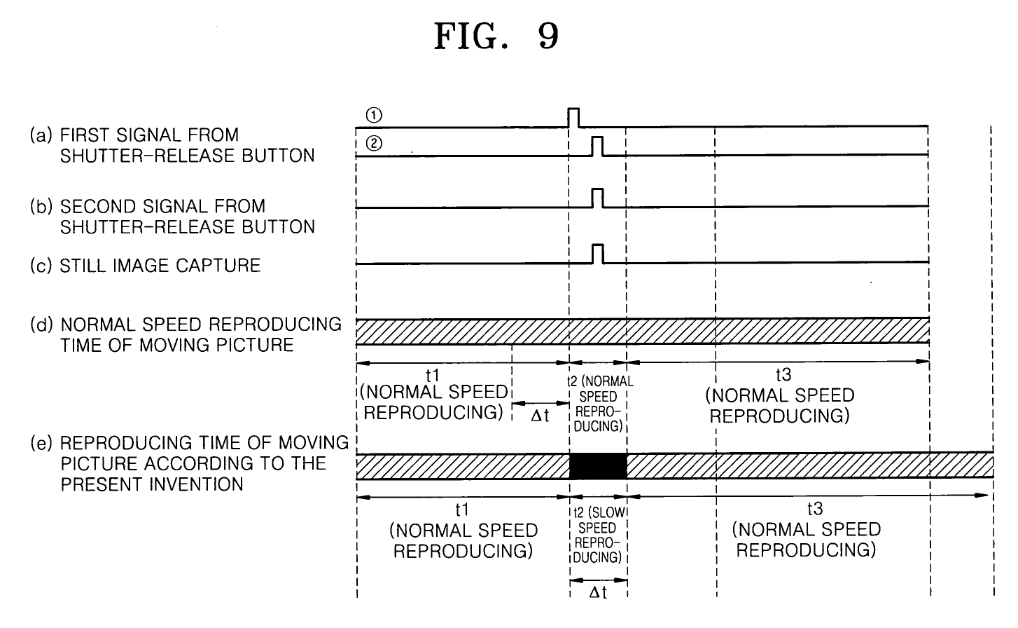

FIG. 9 is a timing diagram of the method illustrated in FIG. 8. In FIG. 9, (a) denotes the first signal from the shutter-release button 11; (b) denotes the second signal from the shutter-release button 11; (c) denotes capture of still images at the input of the second signal from the shutter-release button 11; (d) denotes a normal speed reproducing time of the moving picture; and (e) denotes a reproducing time of the moving picture according to the first embodiment of the present invention. Referring to FIG. 9, when the first signal from the shutter-release button 11 is just briefly input once without being input continuously, the moving picture is shifted back by Δt from a point of time corresponding to the input of the first signal from the shutter-release button 11 and is reproduced at the slow speed. Thereafter, if the first and second signals from the shutter-release button 11 are consecutively input, a still image is captured.

When the moving picture is reproduced at normal speed, as illustrated in FIG. 9(d), the moving picture is reproduced at normal speed during all sections t1, t2, and t3, even if the moving picture is shifted back by Δt by the input of the first signal from the shutter-release button 11. However, as illustrated in FIG. 9(e), when the first signal from the shutter-release button 11 is just briefly input (\textcircled{1}) without being continuously input while the moving picture is reproduced at normal speed in the section t1, the moving picture is shifted back by Δt from the point of input of the first signal from the shutter-release button 11 and is reproduced at the slow speed. The section t2, in which the moving picture is reproduced at the slow speed, is the same as Δt. In other words, the moving picture is reproduced at the slow speed until the moving picture is completely reproduced during Δt. Accordingly, in the section t2, as many still images as the user wants can be captured by consecutively inputting the first signal from the shutter-release button 11 (\textcircled{2}) and the second signal from the shutter-release button 11. When Δt ends, the section t3 starts, in which the moving picture is reproduced at normal speed.

Referring to FIGS. 5, 7 and 9, the first through third embodiments are similar in that once the first signal from the shutter-release button 11 is input, the moving picture is shifted back by Δt from the point of time corresponding to the input of the first signal from the shutter-release button 11 and then reproduced at the slow speed. However, in the first and second embodiments illustrated in FIGS. 5 and 7, as long as the first signal from the shutter-release button 11 is continuously input, the moving picture is continuously reproduced at the slow speed. In the third embodiment illustrated in FIG. 9, the moving picture is reproduced at the slow speed during only Δt in response to the input (\textcircled{1}) of the first signal from the shutter-release button 11. In addition, in the first and second embodiments, a still image is captured by inputting the second signal from the shutter-release button 11 while the first signal from the shutter-release button 11 is being input. However, in the third embodiment, a still image is captured by consecutively inputting the first and second signals from the shutter-release button 11.

As described above, according to the present invention, a still image can be easily captured and stored by operating a two-step switch, which is provided in an image reproducing apparatus, while a moving picture is reproduced.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of capturing a still image with an image reproducing apparatus, the method comprising:
reproducing a moving picture at a first speed;
receiving a first input signal during the reproducing step;
in response to receiving the first input signal, reproducing the moving picture at a second speed, the second speed being slower than the first speed;
receiving a second input signal while the moving picture is being reproduced at the second speed; and
in response to receiving the second input signal, capturing a still image from the moving picture while the moving picture is being reproduced at the second speed.

2. The method of claim 1, wherein the image reproducing apparatus is a digital camera that can perform image capturing and reproducing.

3. The method of claim 2, wherein the first and second input signals are respectively first and second shutter-release button input signals of a two-step button of the digital camera.

4. The method of claim 2, wherein the first input signal is a half-pushed shutter signal and the second input signal is a full-pushed shutter signal.

5. The method of claim 3, wherein the moving picture is reproduced at the second speed as long as the first shutter-release button input signal is maintained.

6. The method of claim 3, wherein after the still image is captured in response to the second shutter-release button input signal, the moving picture is reproduced at the first speed.

7. The method of claim 3, wherein, when the first shutter-release button input signal is received once without being maintained, the moving picture is reproduced at the second speed.

8. The method of claim 7, wherein the still image is captured when the first and second shutter-release button input signals are consecutively received.

9. A method of capturing a still image on an image reproducing apparatus, the method comprising:
reproducing a moving picture;
receiving a first input signal while reproducing the moving picture;
in response to receiving the first input signal, shifting the moving picture back from a point of time corresponding to reception of a first input signal by a predetermined interval;
receiving a second input signal; and
in response to receiving the second input signal, capturing a still image from the moving picture as it is being reproduced.

10. The method of claim 9, further comprising reproducing the moving picture at a slow speed from a beginning of the predetermined interval after shifting the moving picture.

11. The method of claim 10, wherein the image reproducing apparatus is a digital camera that can perform image capturing and reproducing.

12. The method of claim 11, wherein the first and second input signals are respectively first and second shutter-release button input signals of a two-step button of the digital camera.

13. The method of claim 12, wherein the first input signal is a half-pushed shutter signal and the second input signal is a full-pushed shutter signal.

14. The method of claim 12, wherein the moving picture is reproduced at the slow speed as long as the first shutter-release button input signal is maintained.

15. The method of claim 12, wherein the still image is captured in response to the second shutter-release button input signal and then the moving picture is reproduced at a normal speed.

16. The method of claim 12, wherein, when the first shutter-release button input signal is received once without being maintained, the moving picture is reproduced at the slow speed.

17. The method of claim 16, wherein, when the first shutter-release button input signal is received, the moving picture is reproduced at a slow speed from the beginning of the predetermined interval during the predetermined interval.

18. The method of claim 17, wherein the still image is captured when the first and second shutter-release button input signals are consecutively received during the predetermined interval.

19. The method of claim 18, wherein the moving picture is reproduced at a normal speed when the predetermined interval has lapsed.

20. An image reproducing apparatus comprising:
a storage unit that stores data representing a moving picture;
a user input means that generates a first signal and a second signal;
a display unit including a display screen that displays the moving picture at a first speed;
a control unit that, in response to the first signal, causes the image reproducing apparatus to perform steps comprising:
shifting the moving picture back by a predetermined interval; and
displaying the moving picture on the display unit from the beginning of the interval at a second speed, the second speed being slower than the first speed;
and in response to the second signal, causes the image reproducing apparatus to perform steps comprising:
capturing a still image from the moving picture while the moving picture is being displayed at the second speed; and
storing the still image in the storage unit.

21. The apparatus of claim 20, further comprising:
a lens that receives light from a source external to the image reproducing apparatus;
a charge-coupled device that converts the light into an analog signal representing the moving picture; and
an analog to digital converter that converts the analog signal into a digital signal representing the moving picture, the data of which is then stored in the storage unit.

22. The apparatus of claim 21, wherein the user input means is a shutter release button having a first position at which it generates the first signal and second position at which it generates the second signal.
